(19) United States
(12) Patent Application Publication
(10) Pub. No.: US 2026/0085796 A1
(43) Pub. Date: Mar. 26, 2026

(54) METHODS AND INTERNET OF THINGS (IoTs) SYSTEMS FOR SMART GAS DISTRIBUTION PIPELINE PURIFICATION

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Lei ZHANG, Chengdu (CN); Feng WANG, Chengdu (CN); Yuefei WU, Chengdu (CN)

(73) Assignee: CHENGDU QINCHUAN IOT TECHNOLOGY CO., LTD., Chengdu (CN)

(21) Appl. No.: 19/404,072

(22) Filed: Dec. 1, 2025

(30) Foreign Application Priority Data
Jun. 6, 2025 (CN) 202510751634.9

(51) Int. Cl. F17D 5/00; G05B 13/02; G16Y 10/35; G16Y 20/20; G16Y 40/35

(52) U.S. Cl. CPC F17D 5/005; G05B 13/0265; G16Y 10/35; G16Y 20/20; G16Y 40/35

(57) ABSTRACT

A method and an IoTs system for smart gas distribution pipeline purification is provided. The method may include: determining a target cleanliness level based on a terminal user feature; determining a cleanliness deviation based on the initial cleanliness level and the target cleanliness level; generating a purification instruction based on the cleanliness deviation to control a purification device in the target distribution pipeline for gas purification; in response to the execution of the purification instruction, obtaining a flow rate data during a purification period; and generating a flow rate regulation instruction based on the flow rate data, and transmitting the flow rate regulation instruction to the smart gas device object platform.

### CROSS-REFERENCE TO RELATED APPLICATIONS

This application claims priority of Chinese Patent Application No. 202510751634.9, filed on Jun. 6, 2025, the entire contents of which are incorporated herein by reference.

### TECHNICAL FIELD

The present disclosure relates to the field of gas purification, and in particular, to methods and Internet of Things (IoTs) systems for smart gas distribution pipeline purification.

### BACKGROUND

In the process of gas transportation management, a gas gate station or a regulator station may purify the gas to remove impurities. However, there is still a possibility of incomplete removal, resulting in a certain amount of impurity residue in the gas transmitted out of the station. Furthermore, as gas is transported through the network to the user, impurities from the pipeline itself (caused by prolonged use, aging, or microbial corrosion in some sections) may mix into the gas stream, leading to a deterioration in gas cleanliness. Some users, especially industrial users, require gas with better cleanliness to reduce its impact on equipment and products. How to purify the gas within the pipeline network to ensure users receive gas that meets the required standards is an urgent problem that needs to be solved.

Therefore, it is necessary to provide a method and Internet of Things (IoTs) system for smart gas distribution pipeline purification, so as to provide users with gas of higher cleanliness.

### SUMMARY

One or more embodiments of the present disclosure provide a method for smart gas distribution pipeline purification based on Internet of Things (IoTs). The method for smart gas distribution pipeline purification based on Internet of Things (IoTs) comprises: determining an actual cleanliness level of a target distribution pipeline based on an initial cleanliness level of gas to be transported, a first pipeline feature, a first gas feature, a second pipeline feature, and a second gas feature; wherein the first pipeline feature and the first gas feature relate to a main pipeline in a gas pipeline network, the second pipeline feature relate and the second gas feature relate to the target distribution pipeline in the gas pipeline network, the first pipeline feature, the first gas feature, the second pipeline feature, and the second gas feature are obtained from a smart gas device object platform; determining a target cleanliness level based on a terminal user feature, wherein the terminal user feature is obtained from a smart gas government safety supervision and management platform; determining a cleanliness deviation based on the initial cleanliness level and the target cleanliness level; generating a purification instruction based on the cleanliness deviation, and transmitting the purification instruction to the smart gas device object platform to control a purification device in the target distribution pipeline for gas purification; in response to the execution of the purification instruction, obtaining first flow rate data of the main pipeline and second flow rate data of the target distribution pipeline during a purification period from the smart gas device object platform; and generating a flow rate regulation instruction based on the first flow rate data and the second flow data, and transmitting the flow rate regulation instruction to the smart gas device object platform to adjust opening degrees of speed control valves in both the main pipeline and the target distribution pipeline.

One of the embodiments of the present disclosure provides an Internet of Things (IoTs) system for smart gas distribution pipeline purification. The system includes a smart gas government safety supervision and management platform, a smart gas government safety supervision sensor network platform, a smart gas government safety supervision object platform, a smart gas company sensor network platform, and a smart gas device object platform; the smart gas government safety supervision object platform includes a smart gas company management platform, wherein the smart gas company management platform is configured to: determine an actual cleanliness level of a target distribution pipeline based on an initial cleanliness level of gas to be transported, a first pipeline feature, a first gas feature, a second pipeline feature, and a second gas feature; wherein the first pipeline feature and the first gas feature relate to a main pipeline in a gas pipeline network, the second pipeline feature relate and the second gas feature relate to the target distribution pipeline in the gas network, the first pipeline feature, the first gas feature, the second pipeline feature, and the second gas feature are obtained from a smart gas device object platform; determine a target cleanliness level based on a terminal user feature, wherein the terminal user feature is obtained from a smart gas government safety supervision and management platform; determine a cleanliness deviation based on the initial cleanliness level and the target cleanliness level; generate a purification instruction based on the cleanliness deviation, and transmit the purification instruction to the smart gas device object platform to control a purification device in the target distribution pipeline for gas purification; in response to the execution of the purification instruction, obtain first flow rate data of the main pipeline and second flow rate data of the target distribution pipeline during a purification period from the smart gas device object platform; and generate a flow rate regulation instruction based on the first flow rate data and the second flow rate data, and transmit the flow rate regulation instruction to the smart gas device object platform to adjust opening degrees of speed control valves in both the main pipeline and the target distribution pipeline.

One or more embodiments of the present disclosure provide a computer-readable storage medium, wherein the storage medium stores computer instructions, when a computer reads the computer instructions from the storage medium, the computer executes a method for smart gas distribution pipeline purification.

### BRIEF DESCRIPTION OF THE DRAWINGS

This present disclosure will be further illustrated by way of exemplary embodiments, which will be described in detail by means of the accompanying drawings. These embodiments are not limiting, and in these embodiments, the same numbering indicates the same structure, wherein:

FIG. 1 is an exemplary schematic diagram of an Internet of Things (IoTs) system for smart gas distribution pipeline purification according to some embodiments of the present disclosure;

FIG. 2 is a flowchart illustrating an exemplary process for smart gas distribution pipeline purification based on Internet of Things (IoTs) according to some embodiments of the present disclosure;

FIG. 3 is an exemplary schematic diagram of determining an actual cleanliness level according to some embodiments of the present disclosure; and

FIG. 4 is a flowchart illustrating an exemplary process for generating a purification instruction according to some embodiments of the present disclosure.

### DETAILED DESCRIPTION

In order to more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that, as used herein, the terms “system”, “device”, “unit,” and/or “module” are used herein as a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one”, “a”, “an”, “one kind”, and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure. It should be appreciated that the preceding or following operations are not necessarily performed in an exact sequence. Instead, steps can be processed in reverse order or simultaneously. Also, it is possible to add other operations to these processes or to remove a step or steps from these processes.

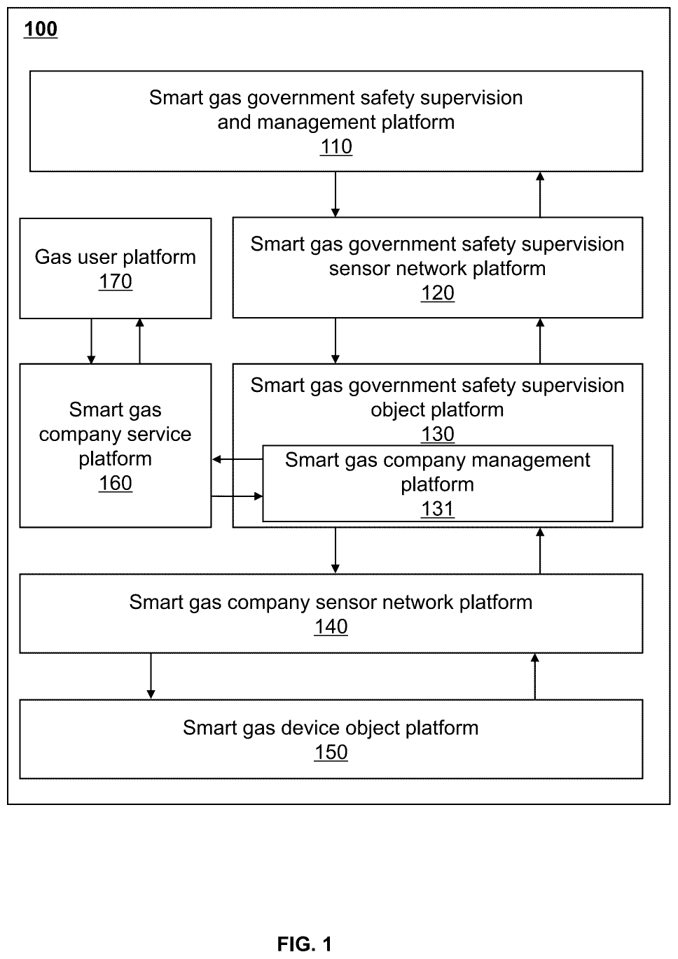

FIG. 1 is an exemplary schematic diagram of an Internet of Things (IoTs) system for smart gas distribution pipeline purification according to some embodiments of the present disclosure. As shown in FIG. 1, the IoTs system for smart gas distribution pipeline purification 100 includes a smart gas government safety supervision and management platform 110, a smart gas government safety supervision sensor network platform 120, a smart gas government safety supervision object platform 130, a smart gas company sensor network platform 140, a smart gas device object platform 150, a smart gas company service platform 160, and a gas user platform 170.

The smart gas government safety supervision and management platform 110 refers to a digital monitoring and management platform through which the government supervises the safety of gas production, transportation, and utilization. In some embodiments, the smart gas government safety supervision and management platform 110 may be configured in a processor and/or a server.

In some embodiments, the smart gas government safety supervision and management platform 110 may include a comprehensive government supervision database. The comprehensive government supervision database refers to a system for integrating and storing relevant data generated during the government supervision process. In some embodiments, the comprehensive government supervision database may integrate and store data and information such as licensing qualifications of the gas enterprise, inspection and maintenance of the gas facilities, and operation of the equipment. In some embodiments, the comprehensive government supervision database may also integrate and store data information such as a terminal user feature, for example, the terminal user feature may include one or more of a civil user scale, an industrial user scale, and an industrial user type of a target distribution pipeline.

In some embodiments, the smart gas government safety supervision and management platform 110 may perform a bidirectional information interaction with the smart gas government safety supervision sensor network platform 120.

The smart gas government safety supervision sensor network platform 120 refers to a communication and transportation platform that allows bidirectional data interaction between one platform and another.

In some embodiments, the smart gas government safety supervision sensor network platform 120 may be configured as a communication network and gateway to enable functions such as network management, protocol management, instruction management, and data parsing.

In some embodiments, the smart gas government safety supervision sensor network platform 120 may connect the smart gas government safety supervision and management platform 110 and the smart gas government safety supervision object platform 130 to realize bidirectional information interaction between the smart gas government safety supervision and management platform 110 and the smart gas government safety supervision object platform 130.

The smart gas government safety supervision object platform 130 refers to an information processing platform used by the government to perform safety supervision of various types of objects involved in gas safety. In some embodiments, the smart gas government safety supervision object platform 130 may obtain information such as the gas operation situation, the gas usage information, and the gas maintenance status of the supervisory objects, and process the information to be uploaded to the smart gas government safety supervision and management platform 110 via a network sensing platform and issue information such as safety supervision requirements. The objects of supervision may include various enterprises, institutions, and individuals involved in gas production, transportation, and use. In some embodiments, the smart gas government safety supervision object platform 130 is provided with a smart gas company management platform 131.

The smart gas company management platform 131 refers to a comprehensive platform designed to coordinate and integrate the connections and collaborations among various functional platforms of the gas company, gather all information of the Internet of Things, and generate instructions by analyzing and processing data and/or information generated in the course of the operation of the gas company. In some embodiments, the platforms on which the smart gas company management platform 131 may interact with the information in both directions are the smart gas government safety supervision object platform 130, the smart gas company sensor network platform 140, and the smart gas company service platform 160.

In some embodiments, the smart gas company management platform 131 may obtain information such as a terminal user feature, a gas usage feature of the user, and a risk level through the smart gas government safety supervision object platform 130. In some embodiments, the smart gas company management platform 131 may upload information such as equipment operation status, purification parameters, feedbacks on supervision requirements, or the like to the smart gas government safety supervision object platform 130.

In some embodiments, the smart gas company management platform 131 may obtain information such as a pipeline feature, a gas feature, flow rate data, or the like through the smart gas company sensor network platform 140; comprehensively analyze and process the relevant information to generate a purification instruction and send the purification instruction to the relevant platform for execution.

In some embodiments, the smart gas company management platform 131 may further include a processor. The processor may process data and/or information obtained from other platforms. The processor may execute program instructions based on such data, information, and/or processing results to perform one or more of the functions described in this disclosure.

The smart gas company sensor network platform 140 refers to a communication and transportation platform that allows for bi-directional interaction of data between functional platforms managed by the gas company. The smart gas company sensor network platform 140 may be configured as a communication network and gateway to realize functions such as network management, protocol management, instruction management, and data parsing.

In some embodiments, the smart gas company sensor network platform 140 may connect the smart gas device object platform 150, the smart gas device object platform 160, and the smart gas company management platform 131 to realize the functions of sensing communication for sensing information and control information sensing communication. For example, the smart gas company sensor network platform 140 may receive data related to the operation of the gas purification device uploaded by the smart gas device object platform 150; and issue the purification instruction from the smart gas company management platform 131 to the smart gas device object platform 150.

The smart gas device object platform 150 refers to a functional platform for sensing information generation. In some embodiments, the smart gas device object platform 150 may be configured as various types of gas equipment. For example, the gas equipment may include gas purification devices, gas flow meters, valve control devices, thermometers, barometers, or the like. In some embodiments, the smart gas device object platform 150 may interact with the smart gas company sensor network platform 140 for data exchange. For example, the smart gas device object platform 150 may upload data related to the operation of the gas purification device, data of gas pipeline features, and gas flow rate to the smart gas company sensor network platform 140.

The smart gas device object platform 150 may further be configured to monitor/detect the gas user terminal and generate sensor information. In some embodiments, the smart gas device object platform 150 may also be configured as various types of gas monitoring/detection equipment. For example, the gas monitoring/detection devices may include gas flow meters, thermometers, gas detectors, or the like. In some embodiments, the smart gas device object platform 150 may interact with the smart gas company sensor network platform 140 for data exchange. For example, the smart gas device object platform 150 may upload gas usage data, gas composition data, combustion gas emission data, or the like to the smart gas company sensor network platform 140.

The smart gas company service platform 160 refers to a platform designed to receive and transmit data and/or information. The smart gas company service platform 160 may interact with the gas user platform 170 and the smart gas company management platform 140 for data exchange. For example, the smart gas company service platform 160 may send operation and management information of the gas purification device to the gas user platform 170. As another example, the smart gas company service platform 160 may send the usage data of gas obtained from the gas user platform 170 to the smart gas company management platform 140.

The gas user platform 170 refers to a platform that interacts with the user. In some embodiments, the gas user platform 170 may be configured as a terminal device, e.g., the terminal device may include a mobile device, a tablet computer, or any combination thereof. In some embodiments, the smart gas company service platform 160 may interact with the user with information via the terminal device. For example, the smart gas company service platform 160 may provide feedback such as gas purification and other information to the user via the terminal device; for another example, the user may upload information such as the gas cleanliness threshold demand, the gas supply abnormality, or the like to the smart gas company service platform 160 via the terminal device.

According to some embodiments of the present disclosure, the IoTs system for smart gas distribution pipeline purification 100 can form a closed loop of information operation between various platforms, and coordinate and regularize the operation under the unified management of the gas company management platform to realize the intellectualization and standardization of the process of the smart gas distribution pipeline purification.

It should be noted that the above description of the IoTs system for smart gas distribution pipeline purification and its modules is only for the convenience of the description, and does not limit this present disclosure to the scope of the cited embodiments. It is to be understood that for a person skilled in the field, after understanding the principle of the system, it may be possible to arbitrarily combine individual modules or form a subsystem to connect with other modules without departing from this principle.

In some embodiments, when realizing the method for smart gas distribution pipeline purification, the smart gas company management platform may determine an actual cleanliness level of a target distribution pipeline based on an initial cleanliness level of gas to be transported, a first pipeline feature, a first gas feature, a second pipeline feature, and a second gas feature; determine a target cleanliness level based on a terminal user feature; determine a cleanliness deviation based on the initial cleanliness level and the target cleanliness level; generate a purification instruction based on the cleanliness deviation, and transmit the purification instruction to the smart gas device object platform to control a purification device in the target distribution pipeline for gas purification; in response to the execution of the purification instruction, obtain first flow rate data of the main pipeline and second flow rate data of the target distribution pipeline during a purification period from the smart gas device object platform; and generate a flow rate regulation instruction based on the first flow rate data and the second flow rate data, and transmit the flow rate regulation instruction to the smart gas device object platform to adjust opening degrees of speed control valves in both the main pipeline and the target distribution pipeline.

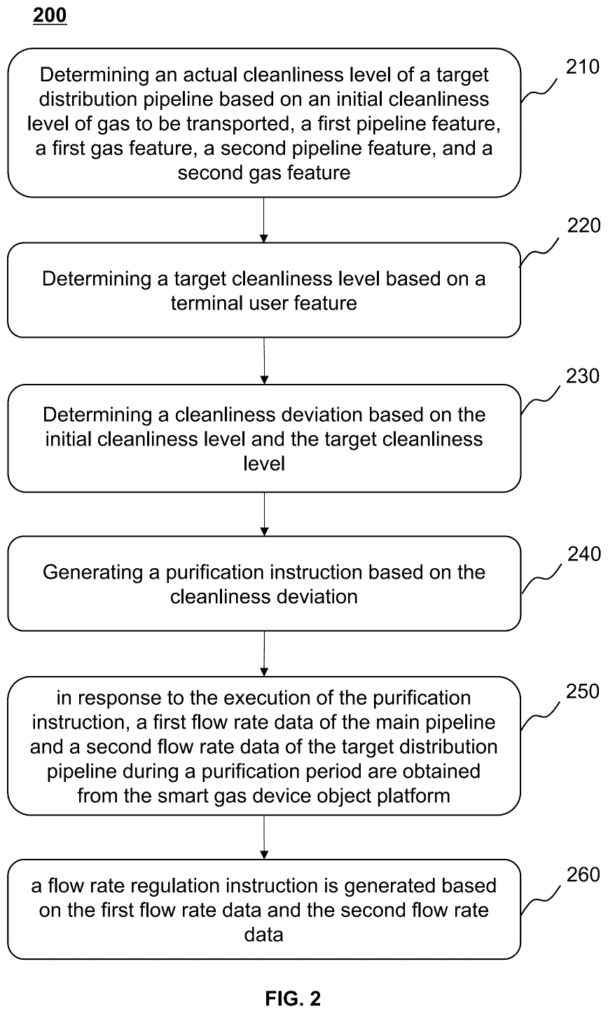

FIG. 2 is a flowchart illustrating an exemplary process for smart gas distribution pipeline purification based on IoTs according to some embodiments of the present disclosure. As shown in FIG. 2, a process 200 may include the following operations. In some embodiments, the process 200 may be performed by a smart gas company management platform of an IoTs system for smart gas distribution pipeline purification.

In 210, an actual cleanliness level of a target distribution pipeline may be determined based on an initial cleanliness level of gas to be transported, a first pipeline feature, a first gas feature, a second pipeline feature, and a second gas feature.

The initial cleanliness level refers to a gas cleanliness level at the gas gate station where the target distribution pipeline is located.

The gas gate station may store and deliver gas to gas users through a distribution gas pipeline. In some embodiments, the gas cleanliness level at the gas gate station is a preset value, which may be determined based on inputs from staff at the gas gate station, and stored in a comprehensive government supervision database of a smart gas government safety supervision and management platform.

In some embodiments, the smart gas company management platform may query from the smart gas government safety supervision and management platform to obtain the initial cleanliness level of the gas to be transported based on the gas gate station where the target distribution pipeline is located.

The gas cleanliness level refers to a degree of gas cleanliness, which may be expressed as a percentage or in other ways. The higher the gas cleanliness level, the lower the amount of impurities in the gas.

The sum of the percentages of the gas cleanliness level and the impurity content is 1. In some embodiments, the smart gas company management platform may determine a gas cleanliness level based on the content of impurities in the gas. The impurities include, but are not limited to, one or more of moisture, sulfide, silicide, solid particles, or the like. The content of impurities in the gas may be determined by one or more of spectroscopy, chromatography, and chemisorption.

The first pipeline feature refers to a pipeline feature at a regulator station or a gas gate station in the main pipeline that is closest to the target distribution pipeline. The being closest to the target distribution pipeline means a pipeline with the smallest distance from the target distribution pipeline. The second pipeline feature refers to a pipeline feature of the target distribution pipeline.

The pipeline feature refers to a feature representing the inherent attributes of gas pipelines. The pipeline feature may include, but is not limited to, at least one of a material of the pipeline, a length of the gas transportation path, an age of the pipeline, a time of cleaning, and a pH of the soil surrounding the pipeline.

In some embodiments, the smart gas device object platform may obtain pipeline information based on user input. The user input may include, but is not limited to, at least one of the material of the pipeline, the length of the gas transportation path, the age of the pipeline, and the time of cleaning, as determined by an operator of the gas pipeline network.

In some embodiments, the smart gas company management platform may obtain the pipeline information from the smart gas device object platform, and determine the material of the pipeline, the length of the gas transportation path, and the age of the pipeline, the time of cleaning, or the like, based on the pipeline information. The smart gas company management platform may also obtain the pH of the soil surrounding the pipeline based on a pH sensor set on the gas pipeline.

The main pipeline is a main part of the gas pipeline. The distribution pipeline refers to a branch of the gas pipeline that is connected to the main pipeline and the terminal user. The target distribution pipeline is a distribution pipeline that requires purification.

The first gas feature refers to a gas feature of the main pipeline. The second gas feature is a gas feature of the target distribution pipeline.

The gas feature is a feature representing a property of the gas. The gas feature includes, but is not limited to, at least one of gas flow rate, pipeline pressure, temperature, or the like.

In some embodiments, the smart gas company management platform may obtain the first gas feature and the second gas feature from the smart gas device object platform. For example, the smart gas company management platform may obtain the first gas feature and the second gas feature from the sensors configured in the smart gas device object platform, such as obtaining the gas flow rate based on a flow rate sensors set in the gas pipeline, obtaining the pipeline pressure based on a pressure sensor set in the gas pipeline, and obtaining the temperature based on a temperature sensor set in the gas pipeline.

The actual cleanliness level refers to a gas cleanliness level at an input end of the purification device in the target distribution pipeline.

The purification device is configured to remove impurities from the gas. In some embodiments, the purification device is disposed in a plurality of locations in the gas pipeline, for example, the purification device is disposed in an individual distribution pipeline, or the like.

In some embodiments, the purification device is an annular purification device disposed in the pipeline. A filtering substance (e.g., activated carbon, silica gel, iron oxide, etc.) is provided inside the purification device. When the purification device is turned on, the gas is input through the input end of the purification device and output from the output end of the purification device, thus realizing the purification of the gas.

In some embodiments, the smart gas company management platform may determine the actual cleanliness level based on the initial cleanliness level, the first pipeline feature, the first gas feature, the second pipeline feature, and the second gas feature, through a cluster analysis.

In some embodiments, the smart gas company management platform may construct a plurality of clustering vectors based on the historical data. The elements of each clustering vector include a historical initial cleanliness level, a historical first pipeline feature, a historical first gas feature, a historical second pipeline feature, a historical second gas feature, and the corresponding historical actual cleanliness level.

In some embodiments, the smart gas company management platform may construct a target clustering vector based on the initial cleanliness level of the gas to be transported, the first pipeline feature, the first gas feature, the second pipeline feature, and the second gas feature. The smart gas company management platform may cluster the clustering vectors and the target clustering vectors to obtain a plurality of clusters based on the initial cleanliness level, the first pipeline feature, the first gas feature, the second pipeline feature, and the second gas feature. The manners of clustering include, but are not limited to, K-Means clustering, mean shift clustering, DBSCAN clustering, or the like.

In some embodiments, the smart gas company management platform may determine a cluster containing a target clustering vector from the foregoing plurality of clusters, and determine an average of the historical actual cleanliness levels of all the clustering vectors in the cluster as the actual cleanliness level corresponding to the target cluster vector.

In some embodiments, the smart gas company management platform may obtain the gas usage data of the terminal user corresponding to the target distribution pipeline from the smart gas device object platform; and determine the actual cleanliness level based on the initial cleanliness level, the first pipeline feature, the first gas feature, the second pipeline feature, the second gas feature, and the gas usage data.

The gas usage data refers to data related to gas usage by a terminal user. In some embodiments, the target distribution pipeline corresponds to a plurality of terminal users, and each terminal user corresponds to gas usage data. The gas usage data includes, but is not limited to, at least one of a daily average gas consumption, a gas combustion color, an emission gas composition, or the like.

In some embodiments, the smart gas company management platform may obtain the emission gas composition of the plurality of terminal users through gas analyzers set in the smart gas device object platform, obtain the gas daily usage data through gas flow meters, and obtain a gas combustion image through user inputs. The smart gas company management platform may determine the daily average gas consumption based on the gas daily usage data, and determine the gas combustion color based on the gas combustion image.

In some embodiments, the smart gas company management platform may determine the actual cleanliness level by vector matching.

In some embodiments, the smart gas company management platform may construct a gas feature vector based on historical gas usage data in the historical data, and determine a historical gas cleanliness level of the distribution pipeline corresponding to the gas feature vector as a label corresponding to the gas feature vector. The gas usage database is obtained based on a plurality of gas feature vector and corresponding labels. The elements of the gas feature vector include an daily average gas consumption, a gas combustion color, and an emission gas composition of the historical terminal user in the historical data.

In some embodiments, the smart gas company management platform may construct a target usage vector based on the gas usage data of the terminal user corresponding to the target distribution pipeline, and match with the gas feature vectors in the gas usage database based on the target usage vector to obtain a plurality of feature vectors whose similarity with the target usage vector is above a similarity threshold. The elements in the target usage vector may include the daily average gas consumption of the terminal user, the gas combustion color, and the emission gas composition. The similarity may be determined by a vector distance, which includes, but is not limited to, a Euclidean distance, a cosine distance, or the like. The similarity threshold may be a preset value or set by a human.

In some embodiments, the smart gas company management platform may determine a plurality of feature vectors whose similarity with the target usage vector is above the similarity threshold, determine a mean value of the labels corresponding to the plurality of feature vectors as the first cleanliness, and determine a mean value of the first cleanliness level and the second cleanliness level as the actual cleanliness level. The second cleanliness may be determined based on the initial cleanliness level, the first pipeline feature, the first gas feature, the second pipeline feature, and the second gas feature, by cluster analysis. More descriptions regarding the cluster analysis may be found in the related descriptions above.

In some embodiments, the smart gas company management platform may determine a reference distribution pipeline of the target distribution pipeline in the gas pipeline network and obtain reference usage data corresponding the reference distribution pipeline from the smart gas device object platform; determine an individual interference factor based on the gas usage data and the reference usage data; and determined the actual cleanliness level based on the initial cleanliness level, the first pipeline feature, the first gas feature, the second pipeline feature, the second gas feature, the gas usage data, and the individual interference factor.

In some embodiments, a plurality of main pipelines may be included in the gas pipeline network, and one main pipeline may correspond to a plurality of distribution pipelines. The main pipeline corresponding to the target distribution pipeline may be referred to as a target main pipeline.

The reference distribution pipeline refers to a distribution pipeline corresponding to the target main pipeline other than the target distribution pipeline.

The reference usage data refers to gas usage data of the terminal user corresponding to the reference distribution pipeline.

The individual interference factor reflects a degree of influence of at least one terminal user corresponding to the target distribution pipeline on the gas usage volume.

In some embodiments, the smart gas company management platform may determine a difference between the average value of the rate of change in the daily average gas consumption of the plurality of reference distribution pipelines and the rate of change in the daily average gas consumption of the target distribution pipeline, as an individual interference factor.

In some embodiments, the rate of change in the daily average gas consumption is expressed as a ratio of the difference between the daily average gas consumption of the two days before and after, and the daily average gas consumption of the previous day.

In some embodiments, the smart gas company management platform may update the daily average gas consumption corresponding to the target distribution pipeline based on the individual interference factor, and determine the updated daily average gas consumption as the gas usage data; and determine the actual cleanliness level based on an initial cleanliness level, the first pipeline feature, the first gas feature, the second pipeline feature, and the second gas feature. More detailed descriptions may be found in the related descriptions above.

In some embodiments, the daily average gas consumption corresponding to the target distribution pipeline is positively correlated with the individual interference factor. For example, the smart gas company management platform may determine the updated daily average gas consumption by following formula (1).

$${P}_{n} = ( R + f + 1 ) \times {P}_{o} \qquad ( 1 )$$

where Pₙ is the updated daily average gas consumption, R is a daily average gas consumption change rate of the target distribution pipeline, f is an individual interference factor, and Pₒ is a daily average gas consumption on the previous day of the target distribution pipeline.

The daily average gas consumption corresponding to the terminal user may fluctuate due to the actual situation, which leads to the change of the gas usage corresponding to the target distribution pipeline. In some embodiments of the present disclosure, taking into account the influence of the terminal user on the gas usage, the gas usage of the target distribution pipeline is updated, and the actual cleanliness level is determined based on the updated gas usage, which is more consistent with the actual gas usage, making the obtained actual cleanliness level more accurate.

In some embodiments of the present disclosure, the actual cleanliness level of the gas is determined based on the gas usage data at the user end, which makes the calculation results more accurate.

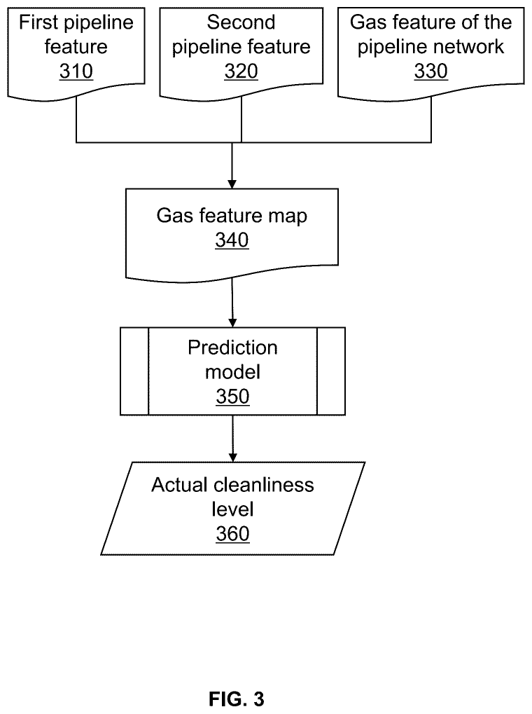

In some embodiments, the smart gas company management platform may obtain a gas feature of the pipeline network collected by the monitoring device in the gas pipeline network from the smart gas device object platform; constructs a gas feature map based on the first pipeline feature, the second pipeline feature, and the gas feature of the pipeline network; and determine the actual cleanliness level based on the gas feature map by a prediction model. More descriptions regarding the prediction model may be found in FIG. 3 and related descriptions thereof.

In 220, a target cleanliness level is determined based on a terminal user feature.

The terminal user feature is a user feature of the terminal user connected to the target distribution pipeline. In some embodiments, the terminal user includes a residential user, a commercial user, an industrial user, or the like. The terminal user feature includes at least one of a residential user size, a commercial user size, an industrial user size, an industrial user type, or the like.

In some embodiments, the smart gas company management platform may obtain the residential user size, the industrial user size, and the industrial user type corresponding to each distribution pipeline from the smart gas government safety supervision and management platform, and then obtain the terminal user feature. The smart gas government safety supervision and management platform may count a plurality of terminal users corresponding to each distribution pipeline, and determine the residential user size, the industrial user size, and the industrial user type corresponding to each distribution pipeline.

Different types of terminal users have different needs for the gas cleanliness level. For example, commercial users and industrial users have higher requirements for the gas cleanliness level to ensure equipment life and/or production quality, whereas residential users have relatively lower requirements for the gas cleanliness level but still need to ensure that the gas is free of impurities in order to ensure the safety of gas usage. In addition, different types of industrial users have different requirements for the gas cleanliness level due to the differences in processes, and production standards. Therefore, it is necessary to provide gas that meets the gas requirements of the user according to the feature of the terminal user.

The target cleanliness level is a minimum gas cleanliness level of the target distribution pipeline to meet gas requirements of the terminal user.

In some embodiments, the smart gas company management platform may determine the target cleanliness level based on the terminal user feature by querying a feature comparison table.

The feature comparison table includes a correspondence between the terminal user feature and the target cleanliness level. In some embodiments, the smart gas company management platform may determine an average of the gas cleanliness levels in the historical data when the user has better feedback on the gas usage experience as the target cleanliness level corresponding to the historical terminal user feature. The feedback may be obtained by distributing a questionnaire through the smart gas government safety supervision and management platform. Better feedback means that the user evaluation meets a preset condition, for example, the user rating is above a preset threshold, the user evaluation is better, good, or the like. If the feedback is better, it means that the cleanliness level of the gas output from the distribution pipeline is able to meet the requirements of the terminal users.

In 230, a cleanliness deviation is determined based on the initial cleanliness level and the target cleanliness level.

The cleanliness deviation refers to a difference between the initial cleanliness level and the target cleanliness level.

In some embodiments, the cleanliness deviation may be determined based on the difference between the target cleanliness level and the initial cleanliness level.

In 240, a purification instruction is generated based on the cleanliness deviation.

The purification instruction refers to an instruction for controlling the purification device to purify the gas. In some embodiments, the purification instruction includes a purification parameter of the purification device.

The purification parameter is a parameter of the purification device when purifying the gas. The purification parameter includes, but is not limited to, at least one of a purification power, a purification duration, or the like of the purification device.

It is known that there are two situations regarding the cleanliness deviation: one is that the cleanliness deviation is above a cleanliness deviation threshold, and the other is that it is not above the cleanliness deviation threshold. In some embodiments, in response to the cleanliness deviation being above the cleanliness deviation threshold, the smart gas company management platform may generate a purification instruction to control the purification device to purify the gas so that the gas cleanliness level of the gas in the target distribution pipeline reaches the target cleanliness level.

The cleanliness deviation threshold is a threshold used to determine whether or not to generate a purification instruction. In some embodiments, the cleanliness deviation threshold is correlated with the pipeline distance between the target distribution pipeline and the terminal user. The greater the pipeline distance, the lower the cleanliness deviation threshold.

During transportation of the gas from the target distribution pipeline to the terminal user, the gas cleanliness level further decreases. The greater the pipeline distance between the target distribution pipeline and the terminal user, the more the gas cleanliness level decreases. In order to improve the gas cleanliness level at the terminal user, the gas cleanliness level at the target distribution pipeline needs to be improved, and the cleanliness deviation threshold needs to be reduced accordingly.

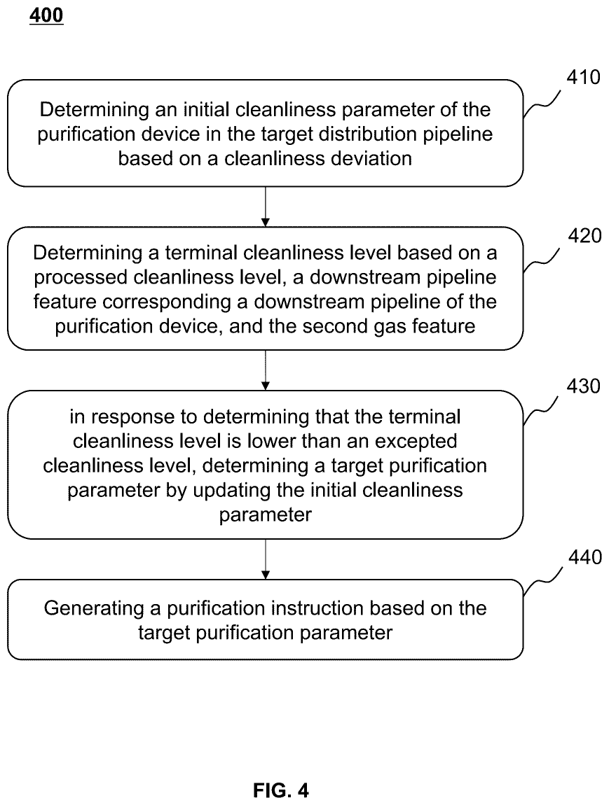

In some embodiments, the smart gas company management platform may determine an initial cleanliness parameter of the purification device in the target distribution pipeline based on the cleanliness deviation; determine a terminal cleanliness level based on a processed cleanliness level, the downstream pipeline feature and the second gas feature corresponding to the downstream pipeline of the purification device; update the initial cleanliness parameter in response to the terminal cleanliness level being lower than a excepted cleanliness level to determine a target purification parameter; and generate the purification instruction based on the target purification parameter. More descriptions regarding the generation of the purification instruction may be found in FIG. 4 and related descriptions thereof.

In some embodiments, the smart gas company management platform may send the purification instruction to the smart gas device object platform to control the purification device in the target distribution pipeline to purify gas in accordance with the purification parameter.

In 250, in response to the execution of the purification instruction, a first flow rate data of the main pipeline and a second flow rate data of the target distribution pipeline during a purification period are obtained from the smart gas device object platform.

The purification period refers to a time period during which the purification device for a localized area performs purification.

The first flow rate data refers to a gas flow rate in the main pipeline close to the target distribution pipeline. In some embodiments, the smart gas company management platform may obtain a plurality of gas flow rates in a preset period based on a flow rate sensor in the main pipeline closest to the target distribution pipeline, and determine an average value of the plurality of gas flow rates as the first flow rate data.

The second flow rate data refers to a gas flow rate in the output end of the purification device for a localized area in the target distribution pipeline. In some embodiments, the smart gas company management platform may obtain a plurality of gas flow rates in a preset period based on a flow rate sensor in the target distribution pipeline closest to the purification device for a localized area; and determine an average value of the plurality of gas flow rates as the second flow rate data.

The preset period may be set according to the actual need, for example, the preset period may be 30 s, 1 min, 2 min, or the like.

In 260, a flow rate regulation instruction is generated based on the first flow rate data and the second flow rate data.

The flow rate regulation instruction refers to an instruction to regulate the gas flow rate. In some embodiments, the flow rate regulation instruction includes, in both the main pipeline and the target distribution pipeline, a speed control valve that needs to be regulated, and a corresponding opening degree of the speed control valve.

The speed control valve is used to regulate the gas flow rate in the gas pipeline, the opening degree of the speed control valve is an angle at which the speed control valve opens, and the gas flow rate is positively correlated with the opening degree of the speed control valve.

It is known that there are two situations regarding the difference between the first flow rate data and the second flow rate data: one is that the difference between the first flow rate data and the second flow rate data is above a flow rate deviation threshold; and the other is that the difference between the first flow rate data and the second flow rate data is not above the flow rate deviation threshold. In some embodiments, in response to the difference between the first flow rate data and the second flow rate data being above the flow rate deviation threshold, the smart gas company management platform may generate a flow rate regulation instruction to regulate the opening degree of the speed control valve in the main pipeline and the target distribution pipeline until the difference between the first flow rate data and the second flow rate data is below the flow rate deviation threshold. As an example, when the second flow rate data is less than the first flow rate data, the opening degree of the speed control valve at the connection between the main pipeline and the target distribution pipeline is gradually increased in a preset step to increase the gas flow rate into the target distribution pipeline, thereby ensuring that the gas flow rate after purification meets the standard. The preset step may be determined based on priori experiences.

The flow rate deviation threshold refers to a threshold for determining whether to generate a flow rate regulation instruction. The flow rate deviation threshold may be set based on experience.

In some embodiments, the flow rate deviation threshold correlates to a density of diversion nodes in the target distribution pipeline. The greater the density of the diversion nodes, the lower the flow rate deviation threshold.

The greater the density of the diversion nodes in the target distribution pipeline, the greater the effect of the disorder in the direction of the gas movement that may be caused by the opening of the negative pressure. At this time, it is necessary to appropriately reduce the flow rate deviation threshold to ensure the sensitivity of the flow rate regulation instruction.

In some embodiments, the smart gas company management platform may send the flow rate regulation instruction to the smart gas device object platform. The smart gas device object platform may adjust the speed control valves in the main pipeline and the target distribution pipeline to a set opening degree.

In some embodiments of the present disclosure, when the cleanliness deviation is relatively large, a purification instruction can be generated in a timely manner to control the purification device to purify the gas, ensuring the gas cleanliness level at the terminal user. In the purification process, real-time monitoring of the gas flow rate in the main pipeline and the target distribution pipeline, timely regulation of the opening degree of the speed control valve when the difference in the gas flow rate is large, can reduce the interference of the purification device on the direction of the gas movement, to ensure the normal transportation of gas.

FIG. 3 is an exemplary schematic diagram of determining an actual cleanliness level according to some embodiments of the present disclosure. As shown in FIG. 3, in some embodiments, the smart gas company management platform may obtain a gas feature of the pipeline network 330 collected by a monitoring device in the gas pipeline network from the smart gas device object platform; construct a gas feature map 340 based on the first pipeline feature 310, the second pipeline feature 320, and the gas feature of the pipeline network 330; and determine the actual cleanliness level 370 via a prediction model according to the gas feature map 340. More descriptions regarding the first pipeline feature, the second pipeline feature, and the actual cleanliness level may be found in FIG. 2 and related descriptions thereof.

The gas feature of the pipeline network includes gas features at a plurality of points in the gas pipeline network. More descriptions regarding the gas feature may be found in FIG. 2 and related descriptions thereof.

In some embodiments, a plurality of predetermined points in the gas pipeline network are provided with a monitoring device, and the monitoring device is configured to collect the gas features of the plurality of predetermined points. The monitoring device may include, but is not limited to, at least one of a flow rate sensor, a pressure sensor, a temperature sensor, or the like, and may be set up according to the actual monitoring needs.

The gas feature map refers to a directed graph characterizing a gas transportation route, reflecting the connection relationship between a main pipeline and a plurality of distribution pipelines, and the gas features of various points in the gas pipeline network.

In some embodiments, the smart gas company management platform may construct the gas feature map based on the first pipeline feature, the second pipeline feature, and the gas feature of the pipeline network.

In some embodiments, the gas feature map may include a plurality of nodes.

In some embodiments, the smart gas company management platform may determine a diversion between a main pipeline and a plurality of distribution pipelines as a node in the gas feature map.

In some embodiments, the nodes in the gas feature map have node features. The node features refer to gas features corresponding to various nodes.

In some embodiments, the smart gas company management platform may determine the node features of the various nodes in the gas feature map based on the gas feature of the pipeline network. For example, when a monitoring device exists at a node, the smart gas company management platform may determine the gas feature at the monitoring device as the node feature of the node. For example, when no monitoring device exists at the node, the smart gas company management platform may determine the gas feature at the monitoring device with the shortest pipeline distance to the node as the node feature of the node.

In some embodiments, the nodes in the gas feature map may be classified according to the locations of the nodes in the gas pipeline network. For example, the nodes in the gas feature map may be classified as upstream-most nodes, downstream-most nodes, and intermediate nodes.

In some embodiments, node features of the upstream-most nodes in the gas feature map further include a gas cleanliness level corresponding to the upstream-most node. The upstream-most node refers to a node corresponding to a monitoring device that is closest to the gas gate station from which the initial cleanliness level is obtained. The gas cleanliness level corresponding to the upstream-most node may be obtained by the aforementioned monitoring device.

In some embodiments, the gas feature map may include a plurality of directed edges connecting the nodes. The edges are oriented to point from an upstream node to a downstream node.

In some embodiments, the smart gas company management platform may determine an edge between two nodes based on a direct connection between the two nodes; and determine the direction of the edge based on the direction of gas transportation between the two nodes.

In some embodiments, the edges in the gas feature map have edge features. The edge features refer to pipeline features of a gas pipeline corresponding to the edge.

In some embodiments, the smart gas company management platform may determine the edge feature of each edge in the gas feature map based on the first pipeline feature, and the second pipeline feature. When the gas pipeline connecting the node A and the node B is a main pipeline, the edge feature is the first pipeline feature corresponding to the main pipeline; when the gas pipeline connecting the node A and the node B is a target distribution pipeline, the edge feature is the second pipeline feature corresponding to the target distribution pipeline; and when the gas pipeline connecting node A and node B is another distribution pipeline, the edge feature is the pipeline feature corresponding to the other distribution pipeline.

In some embodiments, the gas feature map may further include a terminal user node. The node feature of the terminal user node includes gas usage data of the terminal user.

The terminal user node is a node corresponding to a terminal user. The node feature of the terminal user node is the gas usage data of the terminal user. More descriptions regarding the terminal user and the gas usage data may be found in FIG. 2 and related descriptions thereof.

In some embodiments, the terminal user node is connected to a corresponding downstream-most node of the distribution pipeline by an edge that is oriented to point from the downstream-most node to the terminal user node. The edge feature is a pipeline feature of a gas pipeline connecting the terminal user node to the downstream-most node. The downstream-most node refers to a node that is directly connected to the terminal user.

In some embodiments of the present disclosure, terminal user nodes are added to the gas feature map and the gas cleanliness level of the downstream-most node is predicted by the prediction model, and the gas cleanliness level obtained is more accurate.

The prediction model refers to a model predicting the gas cleanliness level at the downstream-most node in the gas feature map. In some embodiments, the prediction model is a machine learning model. For example, a graph neural network (GNN) model, etc.

The input to the prediction model is the gas feature map and the output is the gas cleanliness level at the downstream-most node in the gas feature map. The gas cleanliness level at the downstream-most node refers to the cleanliness level of the gas input to the terminal user.

In some embodiments, the smart gas company management platform may train an initial prediction model to obtain the prediction model based on a plurality of training samples with labels. For example, the smart gas company management platform may input the plurality of training samples into the initial prediction model, construct a loss function based on the outputs of the initial prediction model and the labels, and iteratively update the parameters of the initial prediction model based on the loss function. The model training may be completed when a preset condition is satisfied, and the prediction model may be obtained. The manner of iterative updating includes, but is not limited to, gradient descent. The preset condition may be that the loss function converges, a count of iterations reaches a threshold, or the like.

The training samples include sample gas feature maps. In some embodiments, the smart gas company management platform may construct a sample gas feature map based on a historical first pipeline feature, a historical second pipeline feature, and a historical gas feature of the pipeline network. The labels corresponding to the training samples are the actual gas cleanliness levels at the downstream-most node in the sample gas feature map. The labels may be determined based on data actually obtained by the monitoring device at the downstream-most node in the historical data.

In some embodiments, the smart gas company management platform may perform multiple rounds of training on an initial prediction model based on a plurality of training samples with labels, the multiple rounds of training includes at least one training phrase, each of the at least one training phrase includes a preset count of training rounds; after the end of the training phase, adjust a current learning rate used in the training phase based on a decay factor to obtain an updated learning rate, perform a next round of training based on the updated learning rate; and in response to a training completion condition being triggered, end the training and obtaining a trained prediction model.

In some embodiments, the smart gas company management platform may determine a preset count based on the complexity of the gas feature map. The greater the complexity of the gas feature map, the greater the preset count.

The complexity of the gas feature map represents the complexity level of the gas feature map. In some embodiments, the complexity of the gas feature map is positively correlated with both in-degrees and out-degrees of all nodes in the gas feature map.

The in-degree refers to the number of edges pointing toward a node. The out-degree is the number of edges emanating from a node.

The learning rate determines how quickly and in what direction the parameters of the initial prediction model are updated during training.

In some embodiments, after the end of the training phase, the smart gas company management platform may determine a product of the learning rate and the decay factor of the training phase as the updated learning rate, and perform a next round of training based on the updated learning rate. The decay factor is a number between 0 and 1, and the decay factor may be set based on experience.

As the training process proceeds, the parameters of the initial prediction model gradually approach the optimal solution. In order to avoid parameter oscillations or dispersion caused by a learning rate that is too large, in some embodiments of the present disclosure, the learning rate is gradually reduced by means of a decay factor, which is capable of converging the parameters to the optimal solution.

In some embodiments, the smart gas company management platform may determine the gas cleanliness level at the downstream-most node corresponding to the target distribution pipeline in the gas feature map 340 as the actual cleanliness level 370.

In some embodiments of the present disclosure, predicting the actual cleanliness level by a prediction model can obtain a more accurate prediction result and make the prediction result closer to the actual situation.

FIG. 4 is a flowchart illustrating an exemplary process for generating a purification instruction according to some embodiments of the present disclosure. As shown in FIG. 4, a process 400 may include the following operations. In some embodiments, the process 400 may be performed by a smart gas company management platform of an IoTs system for smart gas distribution pipeline purification.

In 410, an initial cleanliness parameter of the purification device in the target distribution pipeline is determined based on a cleanliness deviation. More descriptions regarding the cleanliness deviation may be found in FIG. 2 and related descriptions thereof.

The initial cleanliness parameter refers to a purification parameter of the purification device that is set initially, and purifying the gas according to the initial cleanliness parameter makes a gas cleanliness level reach a target cleanliness level.

In some embodiments, in response to the cleanliness deviation being above the cleanliness deviation threshold, the smart gas company management platform may generate an initial cleanliness parameter of the purification device in the target distribution pipeline. More descriptions may be found in FIG. 2 and related descriptions thereof.

In 420, a terminal cleanliness level is determined based on a processed cleanliness level, a downstream pipeline feature corresponding a downstream pipeline of the purification device, and the second gas feature.

The processed cleanliness level refers to a gas cleanliness level after it is purified by the purification device. In some embodiments, the processed cleanliness level may be equal to the target cleanliness level.

The downstream pipeline of the purification device is the gas pipeline between the purification device and the terminal user.

The downstream pipeline feature refers to a pipeline feature of the downstream pipeline of the purification device. More descriptions regarding the method for obtaining the downstream pipeline feature may be found in FIG. 2 and related descriptions of the pipeline feature.

The terminal cleanliness level refers to a gas cleanliness level at the terminal user. More descriptions regarding the gas cleanliness level may be found in FIG. 2 and related descriptions thereof.

In some embodiments, the smart gas company management platform may determine the terminal cleanliness level by a manner similar to the manner for determining the actual cleanliness level by cluster analysis described in FIG. 2. The difference is that the elements of each clustering vector include a historical processed cleanliness level, a historical downstream pipeline feature, and a historical second gas feature, and the elements of the target vector include an excepted cleanliness level, a downstream pipeline feature, and a second gas feature. The smart gas company management platform may cluster the clustering vectors and the target vectors based on the gas cleanliness level, the downstream pipeline feature, and the second gas feature.

In some embodiments, the smart gas company management platform may determine the terminal cleanliness level via a prediction model based on the gas feature map. More descriptions regarding the gas feature map and the prediction model may be found in FIG. 3 and related descriptions thereof.

In some embodiments, when the gas feature map includes a terminal user node, the output to the prediction model may also include a terminal cleanliness level at the terminal user node. At this point, the training labels may also include an actual gas cleanliness level at the terminal user node in the historical data.

In some embodiments of the present disclosure, the terminal cleanliness level is predicted by the prediction model, which makes the terminal cleanliness level obtained is more accurate.

In 430, in response to determining that the terminal cleanliness level is lower than an excepted cleanliness level, a target purification parameter is determined by updating the initial cleanliness parameter.

The excepted cleanliness level refers to a minimum gas cleanliness level at the terminal user to meet the gas requirement of the terminal user. In some embodiments, the excepted cleanliness level may have a value equal to the target cleanliness level.

In some embodiments, the gas cleanliness level may further decrease during transportation of the gas from the purification device to the terminal user, at which point the terminal cleanliness level is lower than the excepted cleanliness level, and it is unable to meet the gas requirement of the terminal user. Therefore, it is necessary to make adjustments on the basis of the initial cleanliness parameter, and to determine a target purification parameter to increase the terminal cleanliness level above the excepted cleanliness level.

It is known that there are two situations regarding the terminal cleanliness level: one is that the terminal cleanliness level is lower than the excepted cleanliness level; and the other is that the terminal cleanliness level is not lower than the excepted cleanliness level. In some embodiments, in response to the terminal cleanliness level being lower than the excepted cleanliness level, the smart gas company management platform may update the initial cleanliness parameter through computational simulation to obtain the target purification parameter.

For example, the smart gas company management platform may determine a computational model and set initial parameters according to the actual situation of the purification device, wherein the initial parameters may include an initial power and an initial duration; perform simulation operations based on the aforesaid computational model, and analysis a simulation result to assess whether the purification results under the initial power and the initial duration meet the requirements, and if do not meet the requirements, the initial parameters are gradually adjusted in accordance with the preset rules, and the simulation is performed again until the simulated purification results meet the requirements.

The meet the requirements means that the gas cleanliness level of the purified gas is not lower than the excepted cleanliness level. The preset rules may include: if the gas cleanliness level of the purified gas is lower than the requirements, the initial power may be appropriately increased; if the gas cleanliness level is too high resulting in an increase in energy consumption, the initial power may be appropriately reduced; and if the gas cleanliness level of the purified gas still does not meet the requirements, the initial duration may be extended; if the gas cleanliness level already meets the requirements and continues to increase the length of initial duration does not significantly improve the gas cleanliness level, the initial duration may be shortened to save energy.

In some embodiments, the target purification parameter may include a sub-target purification parameter of at least one preset time phase, the excepted cleanliness level includes a sub-excepted cleanliness level of the at least one preset time phase. The smart gas company management platform may obtain a gas usage feature of a terminal user corresponding to the target distribution pipeline from the smart gas government safety supervision and management platform; determine the sub-excepted cleanliness level of the at least one preset time phase based on the gas usage feature; and for each of the at least one preset time phase, in response to determining that the terminal cleanliness level is lower than the sub-excepted cleanliness level, update the initial cleanliness parameter to determine the sub-target purification parameter.

In some embodiments, the smart gas company management platform may divide a day into a plurality of preset time phases according to a preset duration. For example, if the preset duration is 1 hour, the preset time phase may include 0:00˜1:00, 1:00˜2:00, . . . , 23:00˜24:00. The preset time phase may also be obtained by dividing them in other ways.

The gas usage feature of the terminal user refers to a feature associated with the gas usage of the terminal user. The gas usage feature of the terminal user may include a gas usage time period for each terminal user and a cleanliness level requirement threshold, or the like.

The cleanliness level requirement threshold refers to a minimum gas cleanliness level that satisfies the gas requirement of the terminal user.

In some embodiments, the smart gas company management platform may obtain the gas usage time period of the terminal user from the smart gas device object platform.

In some embodiments, the smart gas company management platform may obtain a cleanliness level requirement threshold from the smart gas government safety supervision and management platform. The smart gas government safety supervision and management platform may determine the terminal cleanliness level corresponding to when the user experience is average as the cleanliness level requirement threshold by distributing a questionnaire to the terminal user. More descriptions may be found in FIG. 2 and related descriptions thereof.

In some embodiments, for a preset time phase, the smart gas company management platform may determine cleanliness level requirement thresholds for a plurality of terminal users that need to use gas in the preset time phase, and determine a maximum value of the cleanliness level requirement threshold as a sub-excepted cleanliness level for the preset time phase.

It is known that there are two situations regarding the terminal cleanliness level: one is that the terminal cleanliness level is lower than the sub-excepted cleanliness level; and the other is that the terminal cleanliness level is not lower than the sub-excepted cleanliness level. In some embodiments, in response to the terminal cleanliness level being lower than the sub-excepted cleanliness level, the smart gas company management platform may update the sub-initial cleanliness parameter by the manner of updating the target purification parameter as described above to determine the sub-target purification parameter.

In some embodiments of this present disclosure, different purification parameters are set according to different needs, which can reduce the frequency of use and replacement of consumables (e.g., filter cartridges) in the purification device, reduce the electrical energy used by the purification device, and achieve cost reduction.

In 440, a purification instruction is generated based on the target purification parameter.

In some embodiments, the smart gas company management platform may send the target purification parameter to the smart gas government safety supervision and management platform to obtain a purification risk level; and generate the purification instruction based on the purification risk level and the target purification parameter.

The purification risk level refers to a level of risk when the purification device performs purification and/or a level of impact on the normal life of the surrounding residents.

In some embodiments, the smart gas government safety supervision and management platform may evaluate the level of risk of a safety hazard in the purification process and the level of impact on the normal life of the surrounding residents based on the operating power and the operating duration of the purification device; and determine the purification risk level based on the level of risk and the level of impact. The purification risk level is positively correlated with the level of risk and the level of impact described above. The smart gas company management platform may obtain the purification risk level from the smart gas government safety supervision and management platform.

In some embodiments, the smart gas government safety supervision and management platform may assess the level of risk and the level of impact based on the frequency, duration, noise level, and noise duration of the pipeline vibration caused by the purification device. The level of risk and the level of impact are positively correlated with the frequency, duration, noise size, and noise duration of the pipeline vibration.

It is known that there are two situations regarding the purification risk level: one is that the purification risk level is above a risk level threshold; and the other is that the purification risk level is not above a risk level threshold. In some embodiments, in response to the purification risk level being above a risk level threshold, the smart gas company management platform may appropriately reduce the cleanliness level requirement, reduce the operating power of the purification device, and extend the operating duration until the new purification risk level is below the risk level threshold. The reduced cleanliness level requirement may be the expected cleanliness level minus the cleanliness deviation threshold. More descriptions regarding the cleanliness deviation threshold and the flow rate deviation threshold may be found in FIG. 2 and related descriptions thereof.

In some embodiments of the present disclosure, the target purification parameter is determined based on the requirement of the terminal user for the gas cleanliness level, and the gas is purified based on the target purification parameter, enabling the purified gas to better meet the gas requirements of the terminal users. When the purification risk level is high, the cleanliness level requirement is appropriately reduced, and the operating power of the purification device is reduced, so as to ensure a higher gas cleanliness level while reducing the risk caused by gas purification.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for smart gas distribution pipeline purification, wherein the method is implemented by a smart gas company management platform of a system for smart gas distribution pipeline purification based on Internet of Things (IoTs), comprising:
determining an actual cleanliness level of a target distribution pipeline based on an initial cleanliness level of gas to be transported, a first pipeline feature, a first gas feature, a second pipeline feature, and a second gas feature; wherein the first pipeline feature and the first gas feature relate to a main pipeline in a gas pipeline network, the second pipeline feature relate and the second gas feature relate to the target distribution pipeline in the gas pipeline network, the first pipeline feature, the first gas feature, the second pipeline feature, and the second gas feature are obtained from a smart gas device object platform;
determining a target cleanliness level based on a terminal user feature, wherein the terminal user feature is obtained from a smart gas government safety supervision and management platform;
determining a cleanliness deviation based on the initial cleanliness level and the target cleanliness level;
generating a purification instruction based on the cleanliness deviation, and transmitting the purification instruction to the smart gas device object platform to control a purification device in the target distribution pipeline for gas purification;
in response to the execution of the purification instruction, obtaining first flow rate data of the main pipeline and second flow rate data of the target distribution pipeline during a purification period from the smart gas device object platform; and
generating a flow rate regulation instruction based on the first flow rate data and the second flow rate data, and transmitting the flow rate regulation instruction to the smart gas device object platform to adjust opening degrees of speed control valves in both the main pipeline and the target distribution pipeline.

2. The method of claim 1, wherein the method further includes:
obtaining gas usage data of a terminal user corresponding to the target distribution pipeline from the smart gas device object platform; and
determining the actual cleanliness level based on the initial cleanliness level, the first pipeline feature, the first gas feature, the second pipeline feature, the second gas feature, and the gas usage data.

3. The method of claim 2, wherein the method further includes:
obtaining a reference distribution pipeline of the target distribution pipeline in the gas pipeline network, and obtaining corresponding reference usage data in the reference distribution pipeline from the smart gas device object platform; wherein the reference usage data refers to data of gas usage of a reference terminal user in the reference distribution pipeline;
determining an individual interference factor based on the gas usage data and the reference usage data; and
determine the actual cleanliness level based on the initial cleanliness level, the first pipeline feature, the first gas feature, the second pipeline feature, the second gas feature, the gas usage data, and the individual interference factor.

4. The method of claim 2, wherein the method further includes:
obtaining a gas feature of a pipeline network collected by a monitoring device in the gas pipeline network from the smart gas device object platform;
constructing a gas feature map based on the first pipeline feature, the second pipeline feature, and the gas feature of the pipeline network; and
determining the actual cleanliness level via a prediction model according to the gas feature map; wherein the prediction model is a machine learning model.

5. The method of claim 4, wherein the method further includes:
performing multiple rounds of training on an initial prediction model based on a plurality of training samples with labels, the multiple rounds of training including at least one training phase, each of the at least one training phase including a preset count of training rounds; wherein
the preset count is determined based on a map complexity of the gas feature map, the map complexity relates to in-degrees and out-degrees of nodes in the gas feature map;
after the end of the training phase, adjusting a current learning rate used in the training phase based on a decay factor to obtain an updated learning rate, performing a next round of training based on the updated learning rate; and
in response to a training completion condition being triggered, ending the training and obtaining a trained prediction model.

6. The method of claim 4, wherein the gas feature map includes a terminal user node, and a node feature of the terminal user node including the gas usage data.

7. The method of claim 1, wherein the method further includes:
determining an initial cleanliness parameter of the purification device in the target distribution pipeline based on the cleanliness deviation;
determining a terminal cleanliness level based on a processed cleanliness level, a downstream pipeline feature corresponding a downstream pipeline of the purification device, and the second gas feature; wherein the terminal cleanliness level refers to a cleanliness level of gas of the terminal user;
in response to determining that the terminal cleanliness level is lower than an excepted cleanliness level, updating the initial cleanliness parameter to determine a target purification parameter; and
generating the purification instruction based on the target purification parameter.

8. The method of claim 7, wherein the target purification parameter includes a sub-target purification parameter of at least one preset time phase, the excepted cleanliness level includes a sub-excepted cleanliness level of the at least one preset time phase;
the method further includes:
obtaining a gas usage feature of a terminal user corresponding to the target distribution pipeline from the smart gas government safety supervision and management platform;
determining the sub-target purification parameter of the at least one preset time phase based on the gas usage feature; and
for each of the at least one preset time phase, in response to determining that the terminal cleanliness level is lower than the sub-excepted cleanliness level, updating the initial cleanliness parameter to determine the sub-target purification parameter.

9. The method of claim 7, wherein the method further includes:
determining the terminal cleanliness level via a prediction model based on a gas feature map; wherein the prediction model is a machine learning model; the gas feature map includes a terminal user node, an output of the prediction model includes the terminal cleanliness level corresponding to the terminal user node.

10. An Internet of Things (IoTs) system for smart gas distribution pipeline purification, wherein the IoTs system includes a smart gas government safety supervision and management platform, a smart gas government safety supervision sensor network platform, a smart gas government safety supervision object platform, a smart gas company sensor network platform, and a smart gas device object platform;
the smart gas government safety supervision object platform includes a smart gas company management platform, wherein the smart gas company management platform is configured to:
determine an actual cleanliness level of a target distribution pipeline based on an initial cleanliness level of gas to be transported, a first pipeline feature, a first gas feature, a second pipeline feature, and a second gas feature; wherein the first pipeline feature and the first gas feature relate to a main pipeline in a gas pipeline network, the second pipeline feature relate and the second gas feature relate to the target distribution pipeline in the gas pipeline network, the first pipeline feature, the first gas feature, the second pipeline feature, and the second gas feature are obtained from a smart gas device object platform;
determine a target cleanliness level based on a terminal user feature, wherein the terminal user feature is obtained from a smart gas government safety supervision and management platform;
determine a cleanliness deviation based on the initial cleanliness level and the target cleanliness level;
generate a purification instruction based on the cleanliness deviation, and transmit the purification instruction to the smart gas device object platform to control a purification device in the target distribution pipeline for gas purification;
in response to the execution of the purification instruction, obtain first flow rate data of the main pipeline and second flow rate data of the target distribution pipeline during a purification period from the smart gas device object platform; and
generate a flow rate regulation instruction based on the first flow rate data and the second flow rate data, and transmit the flow rate regulation instruction to the smart gas device object platform to adjust opening degrees of speed control valves in both the main pipeline and the target distribution pipeline.

11. The IoTs system of claim 10, wherein the system further includes a gas user platform and a smart gas company service platform.

12. The IoTs system of claim 10, wherein the smart gas company management platform is configured to:
obtain gas usage data of a terminal user corresponding to the target distribution pipeline from the smart gas device object platform; and
determine the actual cleanliness level based on the initial cleanliness level, the first pipeline feature, the first gas feature, the second pipeline feature, the second gas feature, and the gas usage data.

13. The IoTs system of claim 12, wherein the smart gas company management platform is configured to:
obtain a reference distribution pipeline of the target distribution pipeline in the gas pipeline network, and obtaining corresponding reference usage data in the reference distribution pipeline from the smart gas device object platform; wherein the reference usage data refers to data of gas usage of a reference terminal user in the reference distribution pipeline;
determine an individual interference factor based on the gas usage data and the reference usage data; and
determine the actual cleanliness level based on the initial cleanliness level, the first pipeline feature, the first gas feature, the second pipeline feature, the second gas feature, the gas usage data, and the individual interference factor.

14. The IoTs system of claim 12, wherein the smart gas company management platform is configured to:
obtain a gas feature of a pipeline network collected by a monitoring device in the gas pipeline network from the smart gas device object platform;
construct a gas feature map based on the first pipeline feature, the second pipeline, and the gas feature of the pipeline network; and
determine the actual cleanliness level via a prediction model according to the gas feature map; wherein the prediction model is a machine learning model.

15. The IoTs system of claim 14, wherein the smart gas company management platform is configured to:
perform multiple rounds of training on an initial prediction model based on a plurality of training samples with labels, the multiple rounds of training including at least one training phase, each of the at least one training phase including a preset count of training rounds; wherein
the preset count is determined based on a map complexity of the gas feature map, the map complexity relates to in-degrees and out-degrees of nodes in the gas feature map;
after the end of the training phase, adjusting a current learning rate used in the training phase based on a decay factor to obtain an updated learning rate, perform a next round of training based on the updated learning rate; and
in response to a training completion condition being triggered, end the training and obtaining a trained prediction model.

16. The IoTs system of claim 14, wherein the gas feature map includes a terminal user node, and a node feature of the terminal user node including the gas usage data.

17. The IoTs system of claim 10, wherein the smart gas company management platform is configured to:
determine an initial cleanliness parameter of the purification device in the target distribution pipeline based on the cleanliness deviation;
determine a terminal cleanliness level based on a processed cleanliness level, a downstream pipeline feature corresponding a downstream pipeline of the purification device, and the second gas feature; wherein the terminal cleanliness level refers to a cleanliness level of gas of the terminal user;
in response to determining that the terminal cleanliness level is lower than an excepted cleanliness level, update the initial cleanliness parameter to determine a target purification parameter; and
generate the purification instruction based on the target purification parameter.

18. The IoTs system of claim 17, wherein the target purification parameter includes a sub-target purification parameter of at least one preset time phase, the excepted cleanliness level includes a sub-excepted cleanliness level of the at least one preset time phase;
wherein the smart gas company management platform is further configured to:
obtain a gas usage feature of a terminal user corresponding to the target distribution pipeline from the smart gas government safety supervision and management platform;
determine the sub-target purification parameter of the at least one preset time phase based on the gas usage feature; and
for each of the at least one preset time phase, in response to determining that the terminal cleanliness level is lower than the sub-excepted cleanliness level, update the initial cleanliness parameter to determine the sub-target purification parameter.

19. The IoTs system of claim 17, wherein the smart gas company management platform is configured to:
determine the terminal cleanliness level via a prediction model based on a gas feature map; wherein the prediction model is a machine learning model; the gas feature map includes a terminal user node, an output of the prediction model includes the terminal cleanliness level corresponding to the terminal user node.

20. A computer-readable storage medium, wherein the storage medium stores computer instructions, when a computer reads the computer instructions from the storage medium, the computer executes a method for smart gas distribution pipeline purification of claim 1.
